(19) United States
(12) Patent Application Publication
(10) Pub. No.: US 2011/0151157 A1
(43) Pub. Date: Jun. 23, 2011

(54) COMPOSITE OBJECT AND METHOD FOR THE PRODUCTION THEREOF

(75) Inventors: Matthias Koebel, Wallisellen (CH); Heinrich Manz, Uster (CH)

(73) Assignee: EMPA EIDGENOSSISCHE MATERIAL-PROFUNGS-UND FORSCHUN, DUBENDORF (CH)

(21) Appl. No.: 12/935,732

(22) PCT Filed: Mar. 30, 2009
(86) PCT No.: PCT/CH09/00107

§ 371 Date: Mar. 4, 2011

(30) Foreign Application Priority Data
Apr. 2, 2008 (CH) 498/08

(51) Int. Cl. C04B 37/00; B32B 17/06; B32B 18/00; C03B 23/20; B32B 3/02; B32B 37/02; B32B 38/00

(52) U.S. Cl. 428/34.6; 428/188; 65/40; 156/272.2

(57) ABSTRACT

A composite object comprises two components (2a, 2b) made of an oxidic material which is ion conductive at an elevated temperature, said components being joined to each other in a medium-tight manner by way of a solder bridge (4) in a connection zone (6) located therebetween. In order to form a reliable connection, it is proposed that the solder bridge is formed by a low-melting tin alloy that has a weight proportion of at least 65%_{w} tin and a melting point of maximally 350° C. and comprises at least one activating metal as an alloying constituent.

### TECHNICAL FIELD

The invention relates to a composite object according to the preamble of claim 1 and to a method for the production thereof.

### PRIOR ART

Composite objects of this category, for example in the form of highly insulating composite panels or packages for micro electromechanic systems (MEMS) and in semiconductor technology, are already known extensively.

Concerning the first mentioned application, a substantial improvement of thermal insulating capability can be achieved by a double panel arranged in a sandwich-like manner with an interspace kept under vacuum. An analogous situation applies to multiple panels.

For the production of such glass composite objects it is well known to hermetically join the components to be connected, particularly glass panels, by a joining process, particularly by a soldering process. In most cases the soldering process is carried out at atmospheric pressure, and thereafter the interspace thus formed is evacuated.

The four soldering materials mentioned hereinbelow are used most commonly.

U.S. Pat. No. 5,902,652 describes the use of a low melting glass solder for joining together two glass panels. The joining process is carried out at about 500° C. and typically requires several hours.

Patent publication US 2002/0088842 describes the use of a metallic solder that is mainly based on tin. Typical melting temperatures are in the range of 250 to 450° C. With this method the glass surfaces in the peripheral regions serving as connection zone first need to be metallized in order to form a surface with good wettability by the solder. Otherwise, no stable solder bridge can be formed.

An improvement of this technology is described in European Patent EP 1 199 289 B1. In said document there is described the direct soldering of activated tin and zinc solder, respectively, onto glass surfaces without prior metallization. However, the connection thus obtained is clearly inferior to an anodic connection as to what concerns mechanical strength and long term stability under load and, therefore, will hardly be applied in practice as an edge joint for evacuated insulating glass.

U.S. Pat. No. 6,444,281 describes the use of a low melting wire based on indium for forming a seal. By this means, the joining process can be carried out at comparatively low temperatures of less than 200° C., and no prior metallization of the glass surface is required. However, the mechanical stability of the composite needs to be reinforced by additional means, particularly through an epoxy adhesion arranged outside of the sealing. The most important obstacle against the commercial adoption of such a technology, however, is the scarcity of indium.

A further approach to be mentioned is the technique of anodic bonding.

U.S. Pat. No. 3,470,348 describes the formation of an anodic connection between an oxidic material, which becomes ion conductive at elevated temperatures, and a metal in liquid state. In this method, the liquid metal is brought to a positive electric potential with respect to the insulator. Upon heating of the insulator, its electric conductivity increases significantly, whereupon an electric current starts to flow. Using an electric current density of, for example, 20 μA/mm², a chemical diffusion layer and, concomitantly, a connection between the metal and the insulator can be formed within about 30 s. However, the solder metals proposed therein are high-melting, toxic or they do not produce, in their available form, a mechanically resistant connection with glass.

The use of anodic bonding for the production of a laminated glass panel is described in U.S. Pat. No. 4,393,105. Therein it is proposed to join a glass panel and a metal frame acting as a spacer. In particular, it is proposed to adopt a metal frame made of aluminum and having a U profile wherein each leg abuts against a respective face of one of the two glass panels. Thereafter, a medium tight connection between the metal frame and the glass panels shall be formed by means of anodic bonding. However, it turns out to be problematic that with such a U profile large size massive support pillars are required, which, however, lead to a highly undesirable heat conduction. Moreover, the production of an anodic joint that seals along the entire circumference is hardly feasible in this manner because a uniform contact with the glass cannot be achieved along the entire circumference.

Anodic bonding has also been considered for the production of micro electromechanic systems (MEMS) but has not become established. For example, Goyal et al. describe a method for joining two pyrex substrates with tin solder, wherein the substrates initially need to be provided with a thin Cr/Au film in the region to be joined (A. Goyal, J. Cheong and S. Tadigadapa, Tin-based solder bonding for MEMS fabrication and packaging applications, J. Micromech. Microeng. 14 (2004) 819-825). Although Goyal et al. indeed briefly mention anodic bonding in the introduction, they dismiss it in view of various purported disadvantages.

### DESCRIPTION OF THE INVENTION

An object of the present invention is to improve a composite object of the above mentioned type and to provide a method for the production thereof.

This object is achieved according to the present invention by means of the characterizing features of claim 1 and by means of the production method according to claim 10.

The composite object according to the present invention comprises two components that are joined to each other in medium tight manner through a solder bridge in a connection zone arranged therebetween. At least one of the components is provided at least at the side thereof facing the connection zone with an outer layer made of an oxidic material which is ion conductive at an elevated temperature.

The solder bridge is made of a low melting tin alloy with a weight proportion of at least 65%_{w} tin and a melting point of maximally 350° C. containing at least one activating metal as an alloying constituent. Here and in the following, the symbol %_{w} will denote percentage by weight. The solder bridge is connected by anodic bonding (AB) with each one of the two components, each of which has an outer layer facing the connection zone that is made of an oxidic material which is ion conductive at elevated temperatures. The alloy can further contain several activating metals.

In a first embodiment at least one of the two components is made entirely of an oxidic material that is ion conductive at elevated temperatures.

In a further embodiment at least one of the two components is made of an electrically insulating core material which is surrounded by an outer layer made of an oxidic material that is ion conductive at elevated temperatures.

In yet a further embodiment at least one of the two components is made of an electrically conductive core material which is provided at least with an outer layer made of an oxidic material that is ion conductive at elevated temperatures.

In a still further embodiment one of the two components is made of a core material that is provided at least with an outer layer made of material that can be conventionally soft soldered with tin solder.

By virtue of the fact that the tin alloy used as solder material has a low melting point, the joining process can be carried out at comparatively low temperatures. In this manner the properties of the components are not adversely affected. For example, components made of annealed glass can be used, and any coatings that are present, such as low emitting layers (engl.: “low E coating”), are not damaged. By virtue of the fact that the tin alloy contains at least one activating metal as an alloying constituent, the wetting of the glass surface with the liquid solder material is considerably better, which is essential for forming the medium tight connection.

According to a further aspect of the invention, there is provided a method for the production of a composite object according to the present invention, which method comprises the steps of:

a1) heating up the two components to a temperature above the melting temperature of the tin alloy serving as solder bridge, with one of the components having previously been covered with a layer of the tin alloy pre-cut in accordance with the connection zone to be connected in medium tight manner;

a2) joining the two components so as to form therebetween the connection zone with the tin alloy arranged therein;

a3) forming the solder bridge by means of anodic bonding AB in liquid state by applying to the tin alloy present in the connection zone a positive voltage of about 300 to 2′000 V with respect to that of each one of the components having an outer layer facing the connection zone made of an oxidic material that is ion conductive at an elevated temperature;

wherein said tin alloy has a weight proportion of at least 65%_{w} tin and a melting point of maximally 350° C. and contains at least one activating metal as an alloying constituent.

According to still a further aspect of the invention, a method for the production of a composite object according to the present invention comprises the steps of:

b1) heating up the two components to a temperature above the melting temperature of the tin alloy serving as solder bridge;

b2) joining the two components in such manner that a connection zone to be connected medium tightly is left free therebetween;

b3) applying the tin alloy in liquid state in such manner that the connection zone is filled therewith;

b4) forming the solder bridge by means of anodic bonding AB in liquid state by applying to the tin alloy present in the connection zone a positive voltage of about 300 to 2′000 V with respect to that of each one of the components (2a, 2b) having an outer layer facing the connection zone made of an oxidic material that is ion conductive at an elevated temperature;

wherein said tin alloy has a weight proportion of at least 65%_{w} tin and a melting point of maximally 350° C. and contains at least one activating metal as an alloying constituent.

The two methods described hereinabove differ, in particular, in the way the solder material is applied. In the first case, a correspondingly pre-cut portion of the tin alloy, for example, a thin, frame-shaped stripe, is laid onto one of the components. Subsequently, the two components are joined in such manner that said pre-cut portion is disposed therebetween in a sandwich-like manner. In the second case, the two components are initially joined in such manner that a connection zone to be filled with the solder material is left open therebetween. Subsequently, the tin alloy in liquid state is filled into said connection zone arranged between the two components.

Although the present context there will always describe the connection of two components, the concept of the present invention can easily be expanded to structures comprising more than two components. In such cases, two components each are connected to each other in accordance with the present invention.

Further preferred embodiments of the present invention are defined in the dependent claims.

In the present context, the term “activating metal” is generally intended to refer to any metallic elements which contribute to easier formation of a connection with the oxidic metal of the respective components, i.e. that are anodically oxidized more easily than tin, and which, moreover, are able to form a mechanically stable oxidized structure in the interface zone and readily form a connection with the glass.

For components made of glass, it is advantageous to form an alloy with aluminum, beryllium, magnesium, calcium, lithium, sodium, potassium, silicon, germanium, gallium or indium as activating metal, but preferably a metal is selected from the group consisting of aluminum, beryllium, magnesium, gallium, indium, lithium and sodium. Particularly preferred are aluminum, lithium and beryllium. It has turned out that when using tin aluminum alloys almost no visible oxide formation occurs on the interface between tin solder and glass, which is essential for forming a uniform and medium tight connection.

Preferably, the weight proportion of activating metal in the tin solder is at least 0.005%_{w} and maximally 5%_{w}.

In principle, the solder bridge can have various geometrical embodiments. For example, the two components can be joined to each other through spot or stripe-like solder bridges. However, to form a medium tightly enclosed interior space between the two components, the solder bridge is advantageously configured in circumferentially shaped manner.

The thickness of the solder bridge, that is, the distance between the two components within the connection zone, can basically be selected from a wide range. As a lower limit, a thickness of about 5 μm has proven successful in order to ensure an entirely continuous solder bridge. The maximum thickness of the solder bridge is not subject to specific limitations and is typically about 1 mm, which is primarily for reasons of production technique, stability and costs.

In an embodiment of the invention, the two components are formed as glass panels. These are provided, particularly for use thereof as a highly insulating composite panel, with a medium tightly closed interior space that is kept under high vacuum.

In a further embodiment of the invention, the two components are formed as glass and/or ceramic platelets that are intended, for example, for use as package for a micro electromechanic or micro electronic device.

In a preferred embodiment of the production method of the present invention, the components are subjected to a cleaning process before or during step a1) and b1) respectively. It will be understood that the cleaning process is selected in accordance with the material of the components and the application field of the composite object.

For example, for the production of highly insulating composite panels, it must be taken into account that water—albeit just in small amounts—adheres very strongly to the glass surface and cannot be completely removed solely by heating (also far above 200° C.). In order to avoid highly undesirable water desorption into the interspace of the finished composite panel, the water should be removed as completely as possible. Moreover, any carbon compounds being present also need to be removed because otherwise they could decompose into small volatile molecules by the uv light of the sun, which also results in an undesirable pressure increase. Water and carbon compounds can be removed using well known methods, with a corresponding pretreatment appropriately being carried out under fine vacuum, i.e. at a residual pressure in the range of about 1 mbar. To this end, carbon compounds can be removed by a treatment with uv light and/or ozone whereas water can be desorbed by heating to >250° C. under high vacuum. Water and carbon compounds can also be efficiently removed by sputtering (e.g. with argon ions).

Depending on the application field and, particularly, on the area of the components to be connected, it is advantageous or even mandatory that upon joining the two components at least one spacer be arranged therebetween.

In general, the method of the present invention can be carried under ambient air but also in an inert gas atmosphere. However, according to a preferred embodiment of the method, steps a1) to a3) and steps b1) to b4), respectively, are carried out under vacuum, preferably at a residual pressure of maximally about 10⁻⁴ mbar. In this process it is important that the vapor and gases emitted upon heating of the components can be pumped off unrestrictedly. One also needs to ensure that the components are spaced apart enough from each other, and, in particular, that no dead volumes are present while degassing.

When operating in a vacuum or under inert gas it has turned out that the presence of a small amount of an oxide of the activating metal, for example, with a weight proportion of maximally 500 ppm, has a favorable influence on the wetting behavior of the liquid tin alloy. If the alloy contains several activating metals, oxides of all of them or of a portion of said activating metals can be present. The improved wetting behavior facilitates a gap-free coating of the connection zone with the liquid tin alloy, thus allowing, for example, the formation of a circumferentially continuous, uninterrupted liquid state solder frame.

The desired metal oxide can be generated by oxidation of the activating component in the liquid state (e.g. Al₂O₃ from Al) under well defined conditions (oxygen concentration, temperature, reactor design and geometry, streaming conditions), for example directly during the production of the solder or before introduction into the high vacuum environment in an oxygen containing atmosphere. Alternatively, the oxidation means required for the oxide formation can be added as a liquid (e.g. H₂O₂), a salt (e.g. KClO₄) or a salt solution to obtain the desired amount of oxide.

Moreover, in the process of manufacturing composite panels a basically known gettering material is laid out in the region between the two glass panels that is surrounded by the connection zone before carrying out the anodic bonding process.

### BRIEF DESCRIPTION OF THE DRAWINGS

Examples of the invention will henceforth be described in more detail by reference to the drawings, which show

FIG. 1 two snap-shots of a first embodiment of the method for the production of a composite object, in a schematic sectional view;

FIG. 2 the anodic bonding process, in a schematic sectional view;

FIG. 3 three snap-shots of a second embodiment of the method for the production of a composite object, in a schematic elevational view;

FIG. 4 a first embodiment of the composite object comprising two components made of an oxidic material that is ion conductive at elevated temperatures;

FIG. 5 a second embodiment of the composite object comprising an upper component made of an oxidic material which is ion conductive at elevated temperatures plus a lower component with an electrically insulating core that is coated with an oxidic material which is ion conductive at elevated temperatures;

FIG. 6 a third embodiment of the composite object comprising an upper component made of an oxidic material which is ion conductive at elevated temperatures plus a lower component with an electrically insulating core that is coated on the upper side thereof with an oxidic material which is ion conductive at elevated temperatures;

FIG. 7 a fourth embodiment of the composite object comprising an upper component made of an oxidic material which is ion conductive at elevated temperatures plus a lower component which is coated on the upper side thereof with a conventionally soft solderable material; and

FIG. 8 a schematic representation of the manufacturing of a highly insulating glass panel.

### MODES FOR CARRYING OUT THE INVENTION

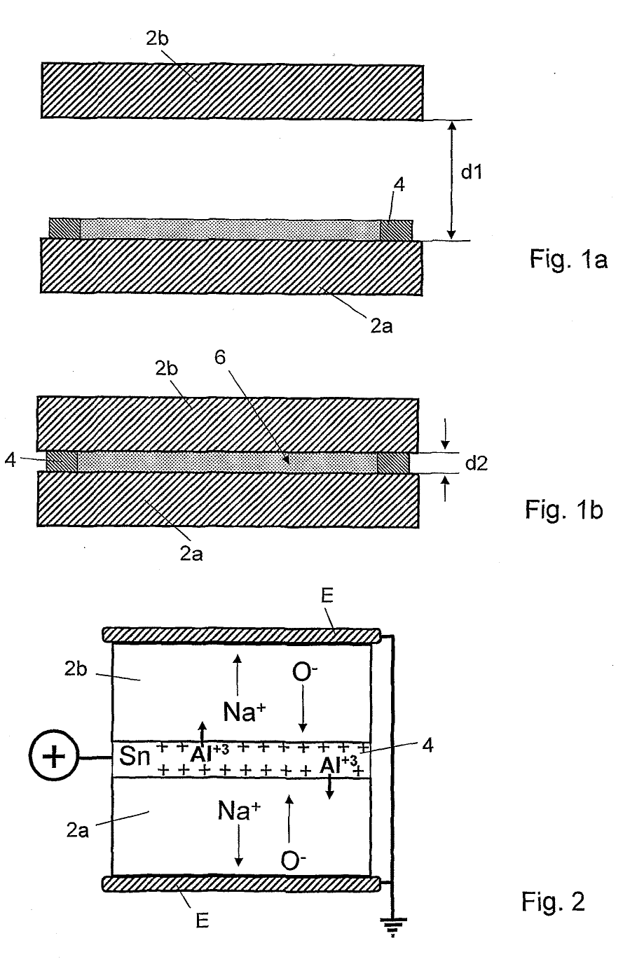

In the embodiment represented in FIGS. 1a and 1b, one initially provides two plate-shaped glass elements 2a and 2b that were previously subjected to a cleaning process. The two glass elements are aligned substantially horizontally and are initially disposed on top of each other at a distance d1 as shown in FIG. 1a. The distance d1 shall be chosen such as to allow for an unproblematic subsequent degassing and will, therefore, be about 5 cm, for example. A layer 4 of a tin alloy is applied to the lower glass element 2a. As will be described below in more detail, the tin alloy in this context is a low melting tin alloy with a melting point of maximally 350° C. and containing at least one activating metal as an alloying constituent. The geometric shape of layer 4 is pre-cut in accordance with the connection zone to be joined in medium tight manner. For example, for forming a medium tightly enclosed interior space 6 that is disposed between the two glass elements 2a and 2b, a frame-shaped layer 4 laid out circumferentially adjacent the edges of the glass elements is used.

Subsequently, the two glass elements 2a, 2b and the tin layer 4 applied thereto are heated up to a temperature above the melting temperature of the tin alloy, for example to 300° C. Advantageously, this step is carried out under fine vacuum in an appropriate chamber as shown in more detail in the examples below. Subsequently, the two glass elements 2a, 2b are joined in such manner that the connection zone 6 with the tin alloy 4 arranged therein is formed therebetween. For example, a distance d2 between the two glass elements 2a, 2b is adjusted to about 200 μm. For this purpose, it is advantageous if corresponding spacers are arranged initially onto the lower glass element 2b.

Finally, a solder bridge is formed by means of anodic bonding by applying to the tin alloy present in the connection zone a positive voltage of about 300 to 2′000 V with respect to that of the two glass elements. The processes taking place are schematically presented in FIG. 2, with the two glass elements 2a, 2b and the tin alloy 4 arranged therebetween being clamped between two grounded electrodes E, and the tin alloy 4 being connected to a positive electrode ⊕. In the liquid tin phase, the activating component, that is, e.g., aluminum, is anodically oxidized and in this process forms a metal ion such as Al⁺³ that diffuses into the glass under the influence of the electric field. At the same time, oxygen ions (formally O⁻) diffuse towards the liquid metal. Consequently, an oxidic diffusion layer is formed that results in a mechanic connection (the so called “anodic bond”). This is only possible because the two oxidic components are ion conductive at the temperature adjusted in the chamber. In addition to the migration of the metal cations formed at the surface, the cations contained in the oxidic component, such as Na⁺ or K⁺, also migrate away from the interface towards the tin alloy; the cations in close proximity of the cathode side ensure charge neutralization. For this reason, the current during the bonding process is defined by the ion conductivity of the oxidic component and the temperature, respectively.

The activating metal that forms an alloy with the tin solder acts against an undesirable formation of tin oxide because it is more easily oxidized than tin, although it cannot prevent it completely. A small amount of the oxide of the activating metal should always be expected upon melting of the solder in the presence of oxygen, that is e.g. in air. Small amounts of such an oxide can even have a positive effect on the entire process: if the solder is applied between two components in its liquid state, it ensures an initial “minimal” wetting and thus allows the formation of a circumferentially continuous, uninterrupted frame of liquid solder. In the absence of any oxide it is likely that the liquid solder will tend to droplet formation due to insufficient wetting, which in turn prevents formation of a circumferentially continuous frame of liquid solder.

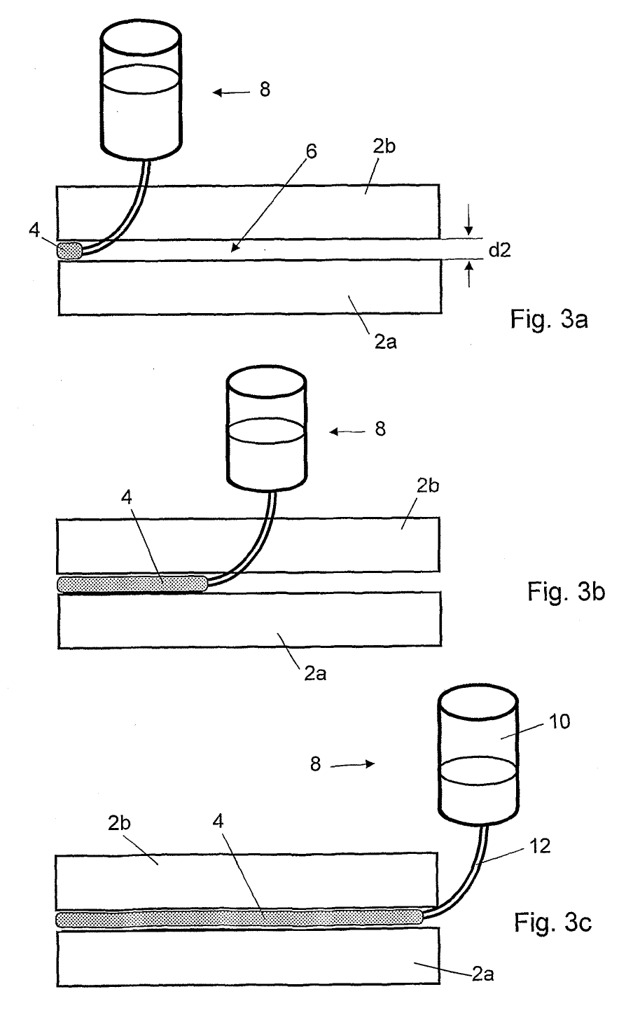

In the embodiment shown in FIGS. 3a to 3c a slightly different sequence of steps is performed. In particular, the two glass elements 2a and 2b are first heated up and degassed. Thereafter, the two glass elements are lined up substantially horizontally and arranged on top of each other at a distance d2 of, for example, 200 μm, which is advantageously achieved by means of appropriately dimensioned support bodies. The connection zone 6 thus formed therebetween is initially left free. Subsequently, the tin alloy 4 in liquid state is introduced laterally between the glass elements 2a, 2b by means of an appropriate supply system 8 in such manner that the connection zone is filled up as desired, i.e. preferably in its peripheral regions. For example, the supply system comprises a heated supply container 10 and a supply pipe 12 provided with a nozzle tip. It will be understood that depending of the situation a fixed arrangement of the glass elements with a circumferentially rotatable supply system or, alternatively, a rotatable arrangement of the glass elements with a stationary supply system can be used. Finally, as already mentioned for the first embodiment, a solder bridge is formed by means of anodic bonding by applying to the tin alloy present in the connection zone a positive voltage of about 300 to 2′000 V with respect to the two glass elements.

The arrangement mentioned just above can be modified in a manner not shown here in detail, according to which the anodic bonding is already induced while applying the tin alloy. In order to achieve this, on the one side, the tin alloy is kept on a positive voltage while being supplied, and, on the other side, a discharging element that is kept on ground potential synchronously extends to the tip of the supply system on each of the two glass elements. In such a case, a solder completely free of oxides can be used also in the vacuum or in an inert gas atmosphere because the wetting is continuously induced by means of the bonding process.

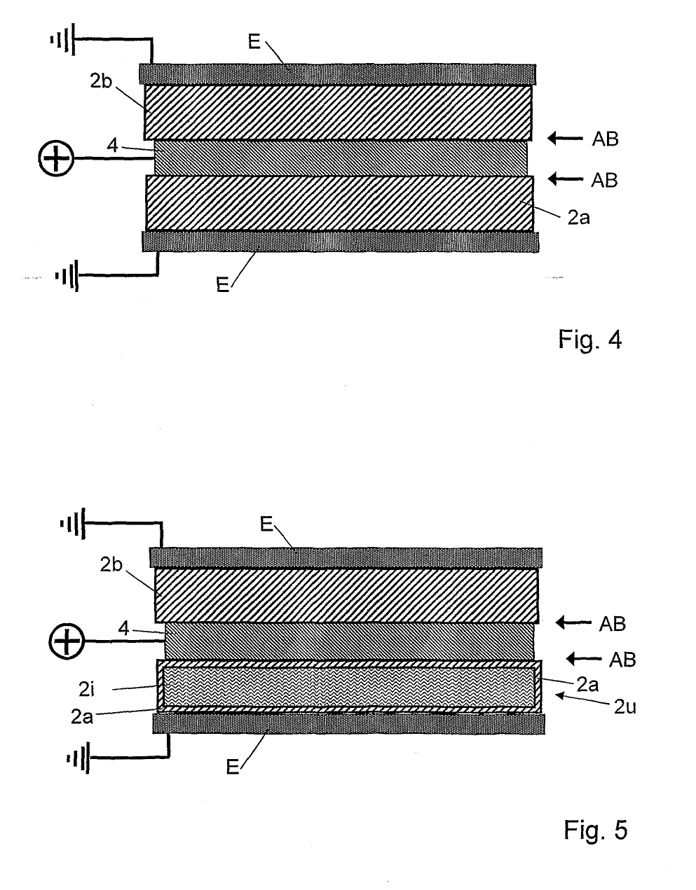

FIGS. 4 to 7 shows various fundamental embodiments of the composite object, each one arranged in the manner as will be used for forming the solder bridge.

The embodiment shown in FIG. 4 comprises two components 2a and 2b, both of which are completely made of an oxidic material that is ion conductive at elevated temperatures. In order to form the solder bridge, the tin alloy 4 is brought to a positive potential while the two components 2a and 2b are kept at ground potential by means of corresponding metal electrodes E. In this manner anodic bonding (AB) occurs at the interfaces between tin alloy 4 and the two components 2a and 2b.

The embodiment shown in FIG. 5 comprises an upper component 2b made of an oxidic material which is ion conductive at elevated temperatures plus a lower component 2u comprising an electrically insulating core 2i, for example made of ceramic, and a coating 2a made of an oxidic material which is ion conductive at elevated temperatures. In order to form the solder bridge, analogously to the case shown in FIG. 4, the tin alloy 4 is brought to a positive potential while the two components 2a and 2b are kept at ground potential by means of corresponding metal electrodes. In this manner anodic bonding (AB) occurs at the interfaces between the tin alloy 4 and the two components 2a and 2u.

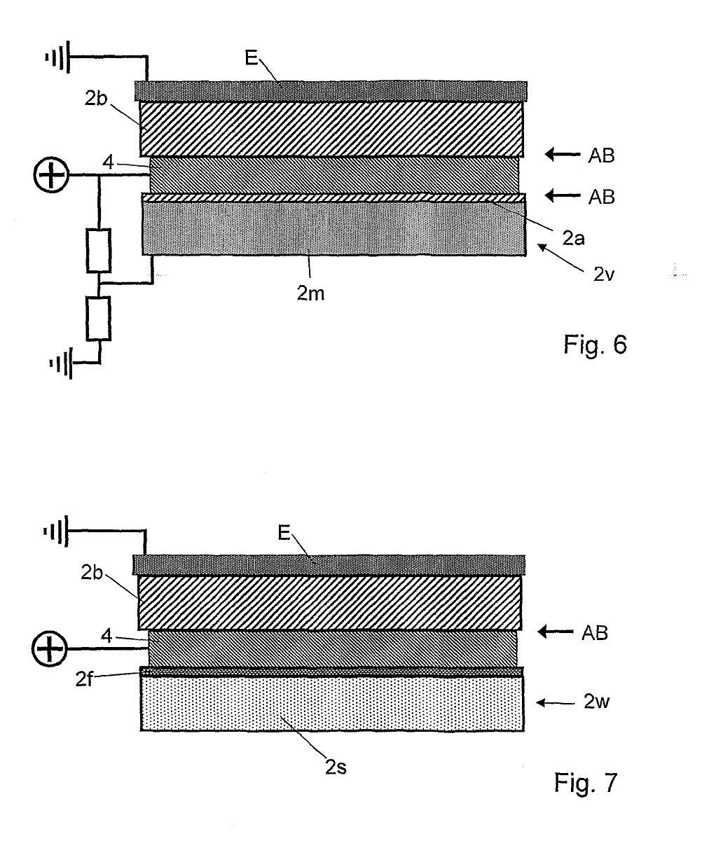

The embodiment shown in FIG. 6 comprises an upper component 2b made of an oxidic material which is ion conductive at elevated temperatures plus a lower component 2v comprising an electrically conducting core 2m, for example a metal plate or a silicon wafer, which is provided on the upper side thereof with a coating 2a made of an oxidic material which is ion conductive at elevated temperatures. In order to form the solder bridge, the tin alloy 4 is brought to a positive potential while the upper component 2b is kept at ground potential by means of a corresponding metal electrode. The electrically conducting core 2m of the lower component 2v acts here as a second counter-electrode. Depending on the thickness of the layer of the ion conductive component 2a, the potential present at the second counter-electrode needs to be adjusted, which is indicated in FIG. 6 by means of a voltage divider circuit. In this manner anodic bonding (AB) occurs at the interface between the tin alloy 4 and the two components 2b and 2v.

The embodiment shown in FIG. 7 comprises an upper component 2b made of an oxidic material which is ion conductive at elevated temperatures plus a lower component 2w comprising an arbitrary substrate layer 2s, for example a silicon wafer, which is coated on the upper side thereof with a material 2f amenable to conventional soft soldering. It is contemplated that 2f can also be a multiple-layer system. In order to form the solder bridge, the tin alloy 4 is brought to a positive potential, while the upper component 2b is kept at ground potential by means of a corresponding metal electrode. In this manner anodic bonding (AB) occurs at the interface between tin alloy 4 and the upper component 2b while at the same time a conventional solder connection is formed between the tin alloy 4 and the lower component 2w. There is no need to apply an elecrtic potential at the lower component 2w.

### Tin Alloys for Anodic Bonding

Table 1 shows a variety of tin containing basic solders comprising activating metal components that are useful for producing composite objects. In the following, the symbol %_{w} will denote percentage by weight.

TABLE 1
Tin containing basic solders

| | Main alloying | | Activating | | Added alloy | | |
|---|---|---|---|---|---|---|---|
| | constituent | | component | | components | | |
| | | Content | | Content | | Content | Melting |
| | Element | [%_{w}] | Element | [%_{w}] | Element | [%_{w}] | point |
| SnAl0.01%_{w} | Sn | 99.9 | Al | 0.01 | — | — | 232° C. |
| SnAl0.6%_{w} | Sn | 99.4 | Al | 0.6 | — | — | 226° C. |
| SnAl2.0%_{w} | Sn | 98.0 | Al | 2 | — | — | 350° C. |
| SnAgAl 3.5; 0.6%_{w} | Sn | 95.9 | Al | 0.6 | Ag | 3.5 | ~221° C. |
| SnAgAlCu 3.0; 0.6; | Sn | 95.9 | Al | 0.6 | Ag, Cu | 3.0; 0.5 | ~217° C. |
| 0.5%_{w} | | | | | | | |
| SnMg1.0%_{w} | Sn | 99 | Mg | 1 | — | — | ~225° C. |
| SnMg3.0%_{w} | Sn | 97 | Mg | 3 | — | — | ~213° C. |
| SnMg5.0%_{w} | Sn | 95 | Mg | 5 | — | — | ~204° C. |
| SnAgMgCu 4.0; 1.0; | Sn | 94.5 | Mg | 1 | Ag, Cu | 4.0; 0.5 | ~216° C. |
| 0.5%_{w} | | | | | | | |
| SnAgMgCu 4.0; 3.0; | Sn | 92.5 | Mg | 3 | Ag, Cu | 4.0; 0.5 | ~204° C. |
| 0.5%_{w} | | | | | | | |
| SnAgMgCu 4.0; 5.0; | Sn | 90.5 | Mg | 5 | Ag, Cu | 4.0; 0.5 | ~204° C. |
| 0.5%_{w} | | | | | | | |
| SnGa0.2%_{w} | Sn | 99.8 | Ga | 0.2 | — | — | 231.5° C. |
| SnGa0.6%_{w} | Sn | 99.4 | Ga | 0.6 | — | — | 228° C. |
| SnGa2.0%_{w} | Sn | 98 | Ga | 2 | — | — | 222° C. |
| SnLi0.01%_{w} | Sn | 99.9 | Li | 0.01 | — | — | 232° C. |
| SnLi0.2%_{w} | Sn | 99.8 | Li | 0.2 | — | — | 227° C. |
| SnLi1.2%_{w} | Sn | 99.4 | Li | 0.6 | — | — | ~280° C. |
| SnZnLiAl | Sn | 69.6 | Li, Al | 0.3 + 0.1 | Zn | 30 | ~325° C. |
| 30; 0.3; 0.1%_{w} | | | | | | | |
| SnZnLiAl | Sn | 69.2 | Li, Al | 0.6 + 0.2 | Zn | 30 | ~335° C. |
| 30; 0.6; 0.2%_{w} | | | | | | | |

Optimizing these solders for a specific application occasionally requires modification of the microstructure of the metal lattice and the associated mechanical properties by varying the added alloying constituents (e.g. Cu, Ag, Zn). This should not influence the effects of the activating components added to the alloy (e.g. Li, Mg, Al, Ga).

### Manufacture of a Composite Panel

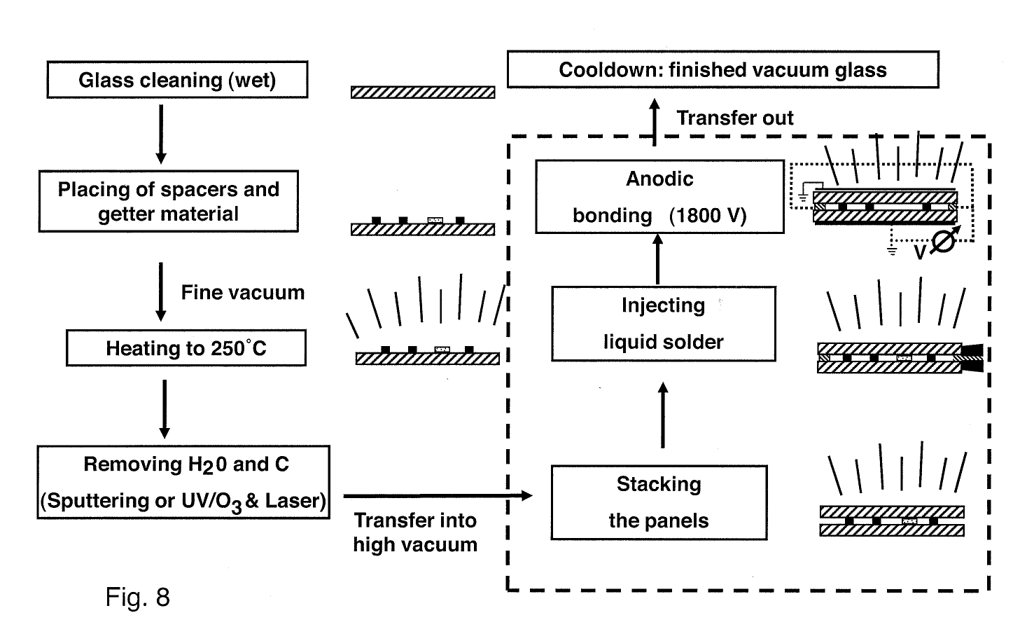

A method for manufacturing a composite panel is illustrated in FIG. 8. Float glass panels with a thickness of 6 mm are initially cleaned with a soap solution and then with water and subsequently rinsed with isopropanol and dried. Any residual carbon impurities on the surface are removed by means of uv/ozone cleaning. Immediately thereafter the glasses are introduced into a pre-vacuum chamber via a gate system where they are heated up to about 200° C. at a chamber pressure of about 0.1 mbar. From there the panels are transferred via a further gate into a high vacuum chamber (HVK) having a background pressure of 10⁻⁶ to 10⁻⁷ mbar. Here the panels are heated further to a temperature between 250° C. and 300° C. At this point the two glasses are arranged directly on top of each other at a distance of about 20 cm. The getter material and a plurality of spacers define the final interspace between the panels (typically 250 μm) are then placed onto the lower half. When the desired temperature has been reached and the pressure gauge in the chamber reads <7·10⁻⁵ mbar, the two panels are moved towards each other until the upper panel lies on top of the spacers over a large area. Then the selected solder compound (for example SnAl0.6% w) in liquid sate is injected into the interspace by means of a revolving injection nozzle, thereby forming a continuously connected solder frame with a width of about 1 cm, which is still liquid because the glass temperature exceeds the melting temperature of the solder. Thereafter the anodic bonding process is carried out: a positive voltage of about 1′800 V with respect to that of the ground electrodes located on the opposite side of the two glass panels is applied for 90 seconds. In this manner, a typical electric current density of 0.6 mA/cm² at 300° C. is reached. The composite object thus produced is cooled down to below the hardening point of the solder of 228° C. and then transferred first into a fine vacuum chamber and then out into the environment by means of a gate system. Consequently, a tight glass composite object (vacuum glass) is obtained featuring an internal pressure <10⁻⁴ mbar, a minimal carbon contamination and comprising a getter material.

### MEMS

In the semiconductor industry, so called “co-fired” ceramic casings are used for packaging of semi conductors and in particular of micro electromechanic systems (MEMS). Such a casing is often produced with multiple layers by laminating a ceramic material in its green, non fired state. The terminology of the package refers to the hermetical sealing of the electronic or MEMS component in the casing.

A casing for semiconductors made of an oxidic ceramic with a content of at least 1%ₘₒₗ Na⁺ or Li⁺ is extensively cleaned from carbon compounds by means of uv/ozone cleaning and the upper face O thereof is just barely immersed into a bath of liquid SnAgMgCu 4.0; 3.0; 0.5%, solder so that a “frame” of this solder with a thickness of about 150 μm remains adhered just at the edge of the upper face. A MEMS acceleration sensor is introduced into the casing and glued to the bottom thereof by means of an epoxy resin. Subsequently, the individual electric connections are formed by means of conventional wire bonding. Thereafter, a properly fitting cover for the casing made of the same ceramic material (or of an optically transparent alkaline rich glass such as, for example, float glass in case an optoelectronic or a MEMS shall be packed) is applied, and the arrangement is clamped between two electrodes at ground potential and heated up to 240° C., whereupon the solder melts. Then, the solder is contacted with an electrically conducting tip and brought to an electric potential of +400V with respect to ground by applying direct current voltage. After 5 minutes the voltage is turned off and the composite object thus formed by anodic bonding is cooled down.

### CIGS (Copper Indium Gallium DiSelenide) Solar Cell

A solar cell panel with dimensions 0.6 m×1.2 m comprising 72 individual CIGS cells is made on a 3 mm thick substrate carrier made of float glass. To begin, the molybdenum electrodes (ca 9 cm×9 cm) were applied by means of lithography and their connection leads were applied by means of a sputtering process (initially 50 nm Cr and subsequently 500 nm Mo) onto the glass substrate. Thereafter the photoactive Cu(In, Ga)Se₂ layer with the desired stoichiometry and thickness (1 to 2 μm) is applied by means of CVD coevaporation using a second mask, followed by a thin foil made of cadmium sulfide CdS with a thickness of 50 nm. Finally, a conductive transparent oxide layer made of doped ZnO is applied by sputtering with a further mask. This last mask is chosen so as to produce a serial circuit of all of the 72 individual cells by means of a local offset in respect of the protruding lower Mo conducting layer. The electric connection to the entire panel to the first and the last cell is then made by means of two Al conductor strips with a width of 2 cm and a thickness of about 150 μm which are insulated with a SiO₂ layer with a thickness of 20 μm and a Cr/Ni layer with a thickness of 50/200 nm. The finished solar cell panel is then hermetically sealed by means of one of the anodic bonding processes described here.

For this purpose, a strip about 2 cm wide at the edge of the panel itself and also at the bottom side of the second cover panel, which is also made of 3 mm thick float glass, is cleaned by means of plasma sputtering. Then the electric feed lines are led to the outside laterally. Thereafter, the two halves are heated up to 270° C. in a nitrogen atmosphere and brought to a mutual distance of 0.5 mm. Subsequently, the SnLi0.01%_{w} solder is introduced laterally by means of a nozzle in such manner that a uniform and uninterrupted frame with a width of about 1 cm is formed over the entire circumference, which, moreover, hermetically surrounds and seals the electric connections that are fed through laterally. The anodic bonding process is initiated by applying a voltage of +1000 V with respect to the frame-shaped counter-electrodes, which are each arranged at the respective opposite side of the glass and at the same temperature level thereof. After 8 minutes the voltage supply is turned off and the solar panel composite object is cooled off. In this manner the finished product is now hermetically sealed. The same method also allows sealing of other types of solar cells such as, for example, polymers, Si, but also Gratzel cells with organic “ionic liquid” electrolytes, where the latter has to be filled in afterwards.

### OLED Displays

OLEDs (Organic Light Emitting Devices) are cheap alternatives to conventional light emitting semiconductor elements. Because of their makeup of organic components and their highly specific surface, OLEDs are extremely oxidation-sensitive. The present application describes the hermetic packaging of an OLED display in an inert gas atmosphere, which allows for complete oxygen exclusion and consequently leads to an extended durability.

An OLED display with dimension 5 cm×9 cm is formed on a n-type semiconducting silicon wafer with a thickness of 0.25 mm, which wafer had previously been provided with an SiO₂ insulator layer by means of an oxygen plasma treatment, by applying a transparent anodic arrangement made of ITO (indium tin oxide) by means of lithography, spin coating (“spincoating”) of the organic layers and vapor deposition of the cathode arrangement (again lithographically from ITO). As a last preparation step, a circumferential stripe with a width of about 1 cm is applied to the edge of the Si wafer by vapor deposition of 100 nm Ti followed by 10 μm Ni by means of a mask, thereby forming a base suitable for soldering. A float glass panel with a thickness of 1 mm is then lowered towards the finished OLED arrangement until reaching a distance of 200 μm. In an inert gas atmosphere, a stripe with a thickness of about 2 cm near the edge of the object to be connected at the upper and lower side thereof is heated up locally to about 270° C. by means of two heated metal frames, and liquid SnAlLi 0.4; 0.2%_{w} solder is introduced laterally through a nozzle system, thereby forming a circumferentially continuous frame. Subsequently the solder is brought to an electric potential of +500V with respect to the heated metal electrode adjacent to the glass side and kept in this manner for 4 minutes. The voltage source is then turned off and the heated metal frame is removed, and the finished, packed OLED display is then cooled off.

### Further Remarks

The electrochemical reaction occurring upon anodic bonding causes the formation of alkaline compounds such as sodium hydroxide (NaOH) in the structure of the ion conductive material at the cathode side. Although only traces of these substances are formed, they can be used for detecting an anodic reaction. In the case of a composite panel, for example, a moist litmus paper on the backside of the glass at the face opposite from the metal frame will indicate the presence of basic components as a blue-violet staining. This staining does not occur in other locations on the glass.

A second and by far much convincing method for detection of anodic bonding is the analysis of polished section samples by means of electron microscopy and energy-dispersive spectroscopy (EDS). For this purpose, a section of the connection zone (glass/solder/glass) with dimension of about 1 cm×1 cm is embedded in epoxy, ground flat, polished and finally coated with a carbon layer of a few nm. Now the cross section is inspected by means of scanning electron microscopy (REM) and EDS. The presence of enrichment and depletion zones in close proximity to the interfaces (about 10 μm) represents clear evidence that anodic bonding was applied.

What is claimed is:

1. A composite object comprising two components (2a, 2b) that are joined to each other in a medium tight manner by way of a solder bridge (4) in a connection zone (6) located therebetween, wherein at least one the components is provided at least at the side thereof facing the connection zone with an outer layer made of an oxidic material that is ion conductive at an elevated temperature, characterized in that the solder bridge is made of a low melting tin alloy with a weight proportion of at least 65%_{w} tin and a melting point of maximally 350° C. containing at least one activating metal as an alloying constituent, wherein the solder bridge is connected by anodic bonding (AB) with each one of the components, each of which has an outer layer facing the connection zone that is made of an oxidic material which is ion conductive at an elevated temperature.

2. The composite object according to claim 1, wherein the activating metal is selected from the group consisting of aluminum, beryllium, magnesium, calcium, lithium, sodium, potassium, silicon, germanium, gallium and indium.

3. The composite object according to claim 1, wherein the activating metal is selected from the group consisting of aluminum, beryllium, magnesium, lithium, sodium, gallium and indium.

4. The composite object according to claim 1, wherein the activating metal is aluminum, lithium or beryllium, particularly aluminum.

5. The composite object according to claim 1, wherein the solder bridge is configured in a circumferentially shaped manner, thereby defining a medium tightly enclosed interior space between the two components.

6. The composite object according to claim 5, wherein the distance between the two components in the connection zone is about 5 to 500 μm.

7. The composite object according to claim 5, wherein the two components are formed as glass panels.

8. The composite object according to claim 7, wherein the medium tightly closed interior space is at a high vacuum, for use as a highly insulating composite panel.

9. The composite object according to claim 1, wherein the two components are formed as glass and/or ceramic platelets, for use as packaging of a micro electromechanic or micro electronic device.

10. A method for the production of a composite object formed by joining two components with a solder bridge, each component having an outer layer made of an oxidic material which is ion conductive at an elevated temperature, the method comprising the steps of:
a1) heating up the two components (2a, 2b) to a temperature above the melting temperature of the tin alloy serving as solder bridge, one of the components (2a) having previously been covered with a layer (4) of the tin alloy pre-cut in accordance with the connection zone to be connected in medium tight manner;
a2) joining the two components (2a, 2b) so as to form therebetween the connection zone (6) with the tin alloy arranged therein; and
a3) forming the solder bridge by anodic bonding in liquid state, by applying to the tin alloy (4) present in the connection zone (6) a positive voltage of about 300 to 2,000 V with respect to that of each one of the components (2a, 2b) having an outer layer facing the connection zone that is made of an oxidic material which is ion conductive at an elevated temperature;
said tin alloy having a weight proportion of at least 65%_{w} tin and a melting point of maximally 350° C. and containing at least one activating metal as an alloying constituent.

11. The method according to claim 10, wherein the components are subjected to a cleaning process before or during step a1).

12. The method according to claim 10, wherein step a2) comprises the insertion of at least one spacer between the two components.

13. The method according to claim 10, wherein steps a1) to a3) are carried out under vacuum.

14. The method according to claim 13, wherein the tin alloy contains an oxide of the at least one activating metal, for improving the wetting behavior.

15. The method according to claim 13 for producing a composite object according to claim 8, wherein, before carrying out the anodic bonding process, a gettering material is laid out in the region between the two glass panels that is surrounded by the connection zone.

16. A method for the production of a composite object formed by joining two components with a solder bridge, each component having an outer layer made of an oxidic material which is ion conductive at an elevated temperature, the method comprising the steps of:
b1) heating up the two components (2a, 2b) to a temperature above the melting temperature of the tin alloy serving as solder bridge;
b2) joining the two components (2a, 2b) in such manner that a connection zone (6) to be connected medium tightly is left free therebetween;
b3) applying the tin alloy (4) in liquid state in such manner that the connection zone (6) is filled therewith; and
b4) forming the solder bridge by means of anodic bonding in liquid state by applying to the tin alloy (4) present in the connection zone a positive voltage of about 300 to 2,000 V with respect to that of each one of the components (2a, 2b) having an outer layer facing the connection zone that is made of an oxidic material which is ion conductive at an elevated temperature;
said tin alloy having a weight proportion of at least 65%_{w} tin and a melting point of maximally 350° C. and containing at least one activating metal as an alloying constituent.

17. The method according to claim 16, wherein the components are subjected to a cleaning process before or during step b1).

18. The method according to claim 16, wherein step b2) comprises the insertion of at least one spacer between the two components.

19. The method according claim 16, wherein steps b1) to b4) are carried out under vacuum.

20. The method according to claim 19, wherein the tin alloy contains an oxide of the at least one activating metal, for improving the wetting behavior.

21. The method according to claim 19 for producing a composite object according to claim 8, wherein, before carrying out the anodic bonding process, a gettering material is laid out in the region between the two glass panels that is surrounded by the connection zone.
